(19) United States
(12) Patent Application Publication
(10) Pub. No.: US 2025/0126532 A1
(43) Pub. Date: Apr. 17, 2025

(54) QUALITY OF EXPERIENCE-BASED USER HANDOFF POLICY

(71) Applicant: AT&T Intellectual Property I, L.P., Atlanta, GA (US)

(72) Inventors: Amit Kumar Sheoran, West Lafayette, IN (US); Yanbing Liu, West Lafayette, IN (US); Xiaofeng Shi, Vernon, CT (US); Jia Wang, Basking Ridge, NJ (US)

(73) Assignee: AT&T Intellectual Property I, L.P., Atlanta, GA (US)

(21) Appl. No.: 18/486,549

(22) Filed: Oct. 13, 2023

(51) Int. Cl. H04W 36/00; H04W 36/22; H04W 36/30

(52) U.S. Cl. CPC H04W 36/008355; H04W 36/0061; H04W 36/22; H04W 36/30

(57) ABSTRACT

Aspects of the subject disclosure may include, for example, receiving a handover request from a user equipment (UE) device in a mobility network, wherein the handover request identifies a target cell for handing over radio communication with the UE device from a source cell, wherein the identifying is based on the handover request, determining a usage level of the UE device, wherein the usage level comprises one of performance-sensitive traffic and performance-tolerant traffic, selecting an alternative target cell for the handover request, wherein the selecting is responsive to determining a performance-sensitive traffic usage level of the UE device, and initiating a handover operation between the source cell and the alternative target cell. Other embodiments are disclosed.

### FIELD OF THE DISCLOSURE

The subject disclosure relates to a handoff policy based on user quality of experience (QoE) in a mobility network.

### BACKGROUND

Cellular handover in conventional networks is dictated by a static policy. When signal strength measurements at a base station from a user equipment (UE) device meet a predetermined threshold, the UE device initiates a handover towards the cell that is considered the best candidate for the handover.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a functional block diagram of a system functioning within the communication network of FIG. 1 in accordance with various aspects described herein.

FIG. 2B is a block diagram illustrating an example, non-limiting embodiment of a prior art system functioning within the communication network of FIG. 1.

FIG. 2C is a block diagram illustrating an example, non-limiting embodiment of a functional block diagram of a system functioning within the communications network of FIG. 1 in accordance with various aspects described herein.

FIG. 2D is a block diagram illustrating an example, non-limiting embodiment of decision-making logic for a quality of experience (QoE) based user handoff system functioning within the communications network of FIG. 1.

FIG. 2E is a block diagram illustrating an example, non-limiting embodiment of a functional block diagram of a system and method functioning within the communications network of FIG. 1 in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for capturing spatial-temporal information about cell site operation in a mobility network and detecting abnormal cells having some performance issue. An example performance issue is a cell heavily loaded with existing traffic. For users who will be handed over to a cell identified as an abnormal cell, a conventional handoff procedure is replaced by a novel handoff decision process based on a user's quality of experience (QoE). This process operates to reject a requested handoff by a user without a high traffic demand. The user's traffic demand is inferred indirectly from the user's operation, such as activity on an interactive application such as voice call or a gaming application. A user in a high-traffic state may be given a new destination cell for handover to maintain the traffic on the user device. Finally, a handoff log is maintained for each user to avoid handover loops. Other embodiments are described in the subject disclosure.

One or more aspects of the subject disclosure include receiving a handover request from a user equipment (UE) device in a mobility network, wherein the handover request identifies a target cell for handing over radio communication with the UE device from a source cell, wherein the identifying is based on the handover request, determining a usage level of the UE device, wherein the usage level comprises one of heavy traffic and light traffic, or performance-sensitive traffic or performance-tolerant traffic, selecting an alternative target cell for the handover request, wherein the selecting is responsive to determining a performance-sensitive traffic usage level of the UE device, and initiating a handover operation between the source cell and the alternative target cell.

One or more aspects of the subject disclosure include receiving, at a cell site of a mobility network, a handover request from a user equipment (UE) device in the mobility network, the UE device attached to the cell site, the handover request including a list of adjacent cell sites detected by the UE device and respective received signal strength information for each adjacent cell site on the list of adjacent cell sites, identifying a target cell for handoff of the UE device based on the list of adjacent cell sites, determining the target cell for handoff is an abnormal cell having an abnormal operating state, and determining a current traffic level type of the UE device. Aspects of the subject disclosure further include rejecting a handover for the UE device in response to the current traffic level type of the UE device corresponding to a light traffic value or a performance-tolerant, selecting an alternative target cell for the handover for the UE device in response to the current traffic level type of the UE device corresponding to a heavy traffic value or a performance-sensitive traffic value, and initiating a handover operation for communication between the UE device and the alternative target cell.

One or more aspects of the subject disclosure include receiving, by an eNodeB device, a handover request from a user equipment (UE) device in a mobility network, identifying a target cell for handoff of the UE device, wherein the target cell is based on information of the handover request, and receiving cell state information for cells of the mobility network, including receiving abnormal cell identification information identifying abnormal cells of the mobility network having an abnormal operating state and receiving normal cell identification information identifying normal cells of the mobility network having a normal operating state. Aspects of the subject disclosure further include identifying the target cell as an abnormal cell, inferring a traffic usage level of the UE device, wherein the traffic usage level is one of heavy traffic at the UE device and light traffic at the UE device, or one or performance-sensitive traffic at the UE device and performance-tolerant traffic at the UE device, selecting an alternative target cell for the handover request, wherein the selecting is responsive to determining a heavy traffic usage level or a performance-sensitive traffic usage level of the UE device, and initiating a handover operation between the eNodeB and the alternative target cell.

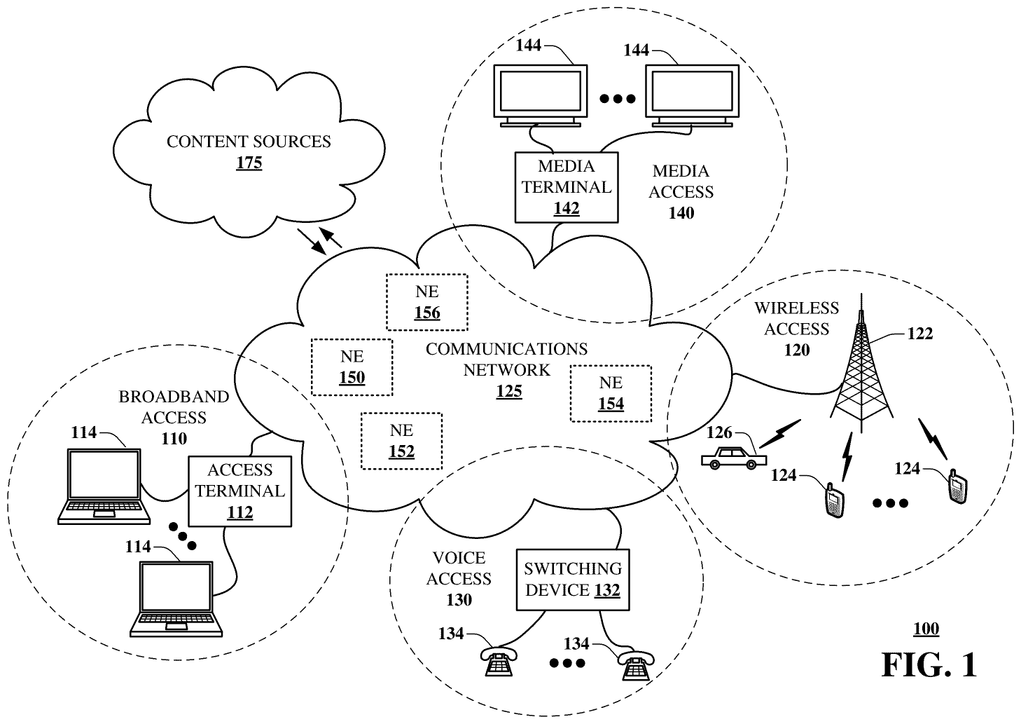

Referring now to FIG. 1, a block diagram is shown illustrating an example, non-limiting embodiment of a system 100 in accordance with various aspects described herein. For example, system 100 can facilitate in whole or in part receiving a handover request from a user equipment (UE) device in a mobility network, determining if a target cell for the handoff is in an abnormal state, such as a cell outage or congestion due to traffic, inferring a type of traffic present in the UE device and selecting an alternative handover target for the handover request. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

Wireless access 120 provides one or more mobility networks with radio communication between one or more base stations such as base station or access point 122 and user equipment (UE) devices such as the plurality of mobile devices 124 and vehicle 126. Each base station serves a coverage area and adjacent coverage areas generally overlap. Each base station may include one or more eNodeB devices, gNodeB devices, or other radio access devices for radio communication with UE devices (generally referred to herein as eNodeB or eNb). As a UE device travels from a first coverage area served by a first base station to a second coverage area served by a second base station, ongoing communication between the first base station and the UE device is handed off or handed over to the second. Prior to the handoff or handover, signaling occurs between the first base station, called the source, and the UE device. This may include reporting by the UE device information about received signal strength from neighboring base stations including the second base station, called the target. The neighboring base stations may be ranked on factors such as received signal strength at the UE device. The signal strength and other information is used to direct and control the handover. Other network components, such as a mobility management entity of a core network of the mobility network, may be involved in the handover process and communicate directly or indirectly with the base stations and the mobile device.

Cellular handover in conventional networks is generally dictated by a static policy. That is, when the UE device signal strength measurements meet a predetermined threshold, the UE device initiates a handover towards a best cell, where the best cell is determined based on signal strength and other factors. Therefore, conventional deployments allow eNodeB devices only a limited opportunity to select the UE devices the eNodeB wants to serve.

In accordance with aspects described herein, eNodeB devices are enabled to select the UE devices that the eNodeB device wants to serve in order to optimize internal resource utilization for the mobility network including the eNodeB device. Further, the eNodeB may implement a per-UE predictive handover policy. This capability is particularly useful in handling user migration during network outages, when one or more base stations is offline. This capability can also be extended to busy hour traffic management in the mobility network and allows an eNodeB device to select the UE devices that it want to serve based on quality of service (QoS) constraints.

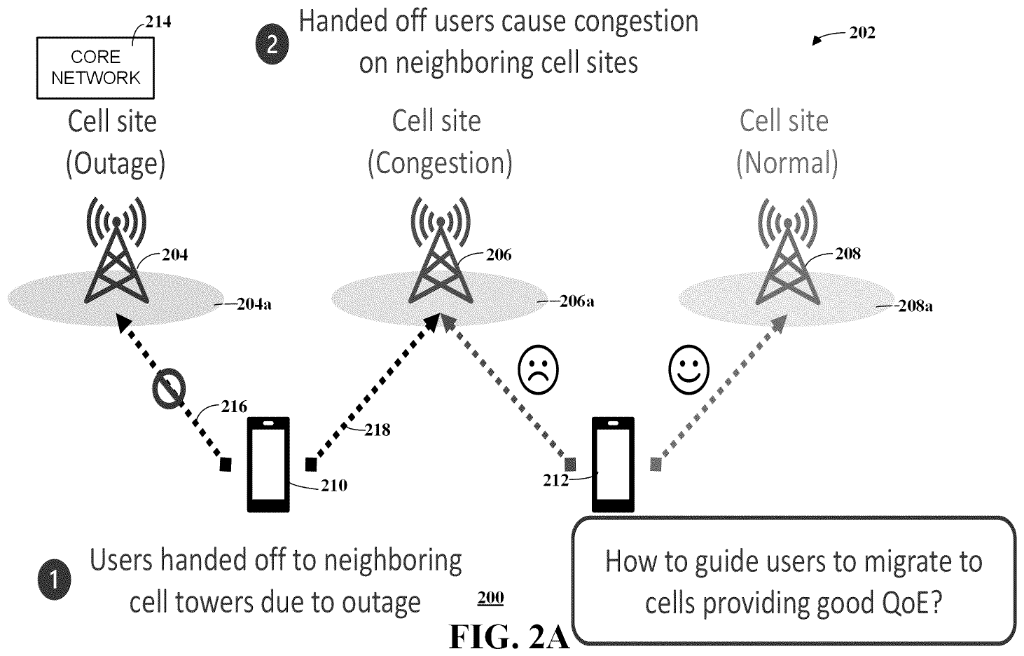

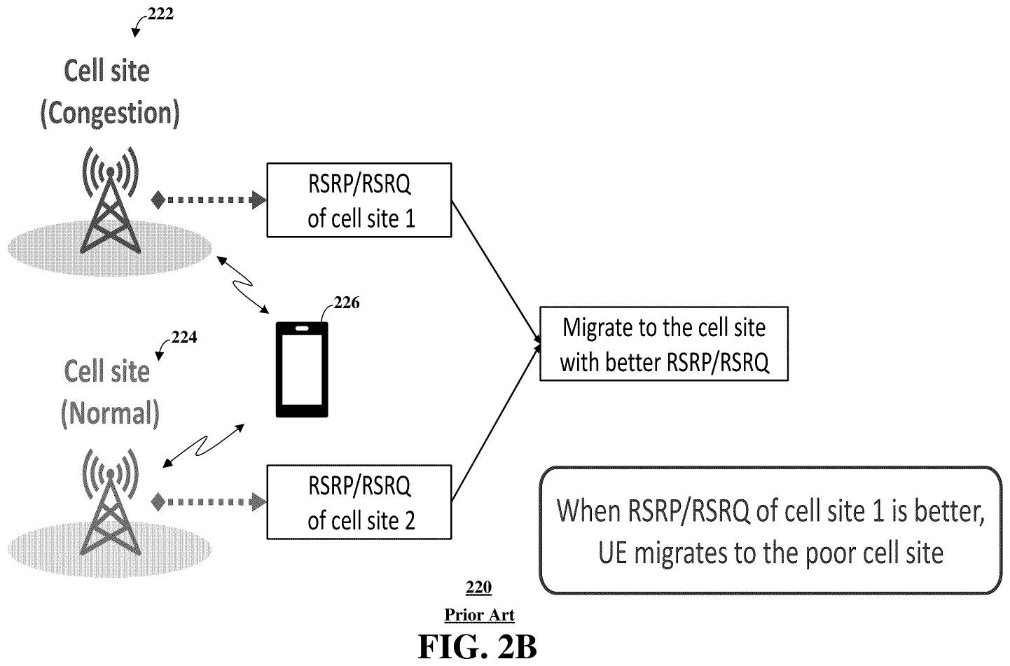

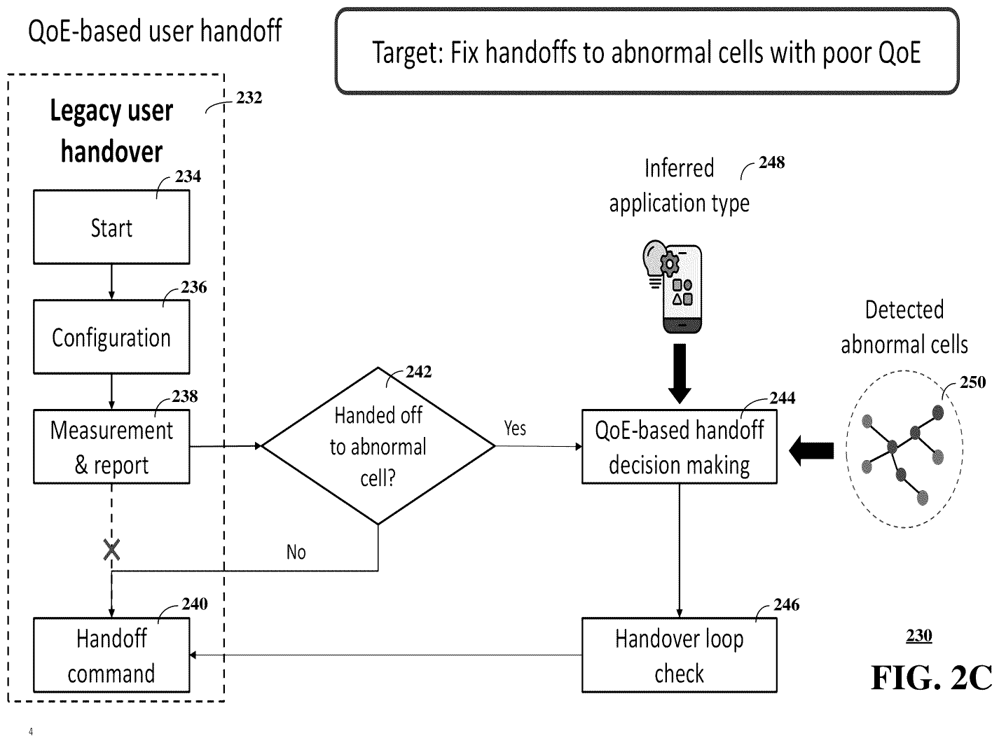

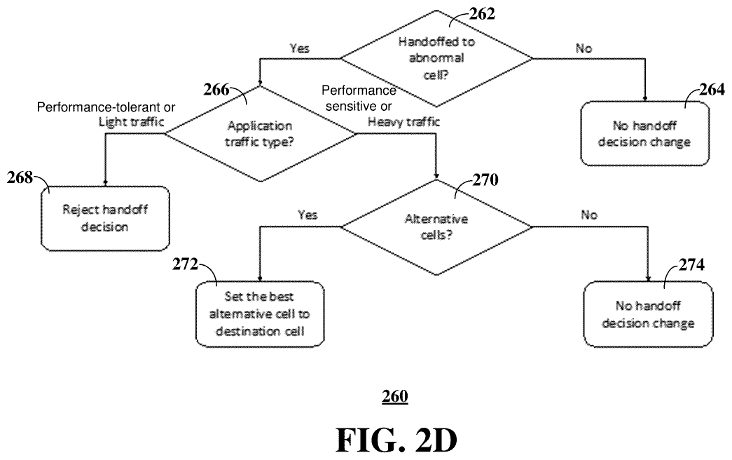

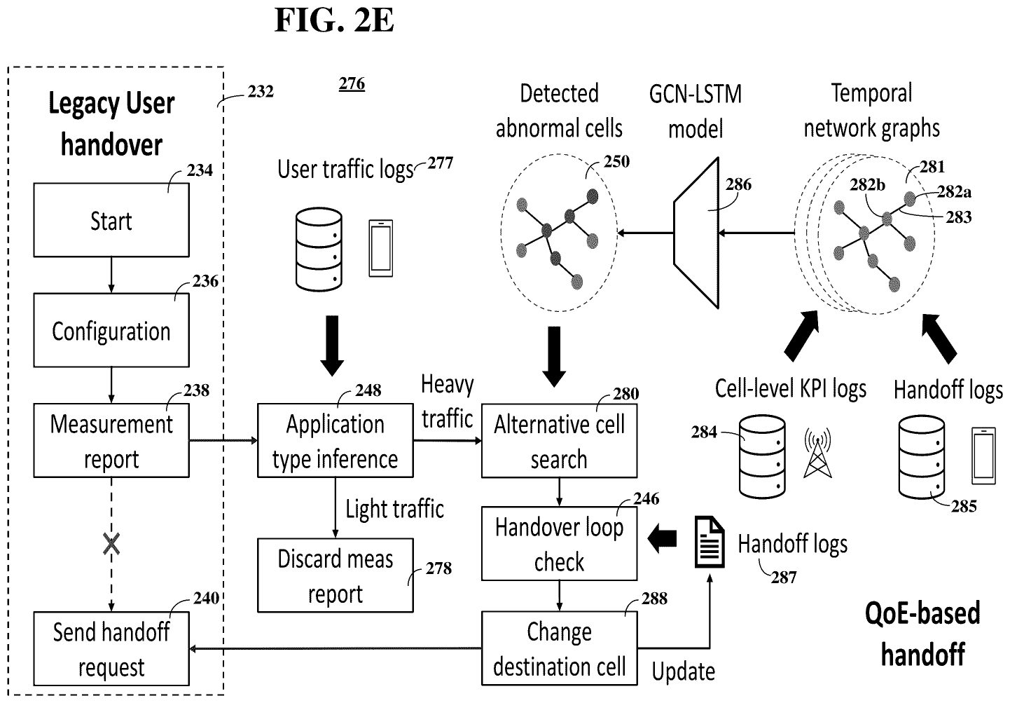

FIG. 2A is a block diagram illustrating an example, non-limiting embodiment of a system 200 functioning within the communications network 125 of FIG. 1 in accordance with various aspects described herein. In the exemplary embodiment, system 200 implements a mobility network 202 including a first base station 204, a second base station 206 and a third base station 208. The first base station 204 provides radio communication to devices in a first service area 204a. The second base station 206 provides radio communication to devices in a second service area 206a. The third base station 208 provides radio communication to devices in a third service area 208a. In addition, the system includes UE devices including first UE device 210 and second UE device 212 in selective radio communication with one or more of the base stations, including the first base station 204, the second base station 206 and the third base station 208. The first base station 204, the second base station 206 and the third base station 208 are generally each in communication with a core network 214 that provides a variety of functions and services, such as mobility management, authorization and accounting, and data communication through a gateway to other networks such as the public internet. The embodiment of FIG. 2A is intended to be exemplary only. Other systems and mobility networks will include other arrangements of base stations and other UE devices active in the network.

In the example of FIG. 2A, a cell site outage has occurred at the first base station 204. In accordance with the cell site outage, the first base station 204 is unable to provide radio communication to UE devices such as first UE device 210 in the first service area. The cell site outage may occur for any reason, such as maintenance at the cell site requiring the cell site to be taken offline or a power outage at the cell site.

The cell site outage may be detected in the system 200 in any suitable manner. For example, the cell site including the first base station 204 may simply become noncommunicative to UE devices or the core network 214. In another example, one or more key performance indicators (KPIs) may be degraded, and this degradation is detected by a supervisory function of the core network 214 or elsewhere. The nature of the outage may vary from a degraded functionality of one aspect of the cell site operation to a full unavailability of the cell site.

As a result of the outage, users such as the first UE device 210 are automatically handed off to neighboring cell sites. In the example of FIG. 2A, a communication link 216 between the first UE device 210 and the first base station 204 is dropped and a new communication link 218 between the first UE device 210 and the second base station 206 becomes active. That is the first UE device 210 is handed off from the first base station 204 to the second base station 206. Other UE devices may be moved to other neighboring cell sites, depending on location, traffic levels and other factors.

In some cases, the cell site including the second base station 206 can begin to experience congestion due to a high level of traffic at the cell site. The high level of traffic is associated with mobile devices such as second UE 212 already active on the cell site including the second base station 206, combined with the added traffic from UE devices such as first UE device 210 which have been handed off to the second base station 206 due to the outage at the first base station 204. The congestion at the second base station 206 may have a negative effect on operation of portions of the system 200, resulting in dropped calls and other errors.

In accordance with various aspects described herein, the mobility network 202 operates to guide users such as second UE device 212 and third UE device 208 to a cell site experiencing normal traffic loads, such as the cell site including the third base station 208. Note that the service areas, including first service area 204a, second service area 206a and third service area 208a may be overlapping so as to enable each respective base station to reliably communicate with the affected UE devices including the first UE device 210 and the second UE device 212. The service areas may not be drawn to scale in FIG. 2A.

The mobility network 202, or components of the mobility network 202 operate to guide users such as first UE device 210 and second UE device 212 to a cell site such as the cell site including the third base station 208 that provides satisfactory quality of experience (QoE) to the user of the UE device. QoE may be defined in any suitable manner and may be subjective for the user. Further, QoE may be a function of the network and of an application the user is making use of on a mobile device. For example, some applications operating on the second UE device 212 have very high data consumption rates, and the network may not have sufficient capacity at the moment or the location where the user seeks to use the application. Examples include interactive applications such as a voice call or a gaming application. At another time or location, when traffic loading and capacity are different, or when using another application, the user's quality of experience may be satisfactory. But at times of network congestion, at the second cell site or elsewhere, the QoE for the user may become unacceptable. Any suitable proxy for QoE may be evaluated and considered. In one example, a mobility network specifies a quality of service (QoS) for a radio link and for a UE device. While QoE evaluates actual individual user experience, QoS measures key network performance metrics. Such metrics may include key performance indicators such as traffic throughput, transit delays or latency, jitter, and others.

FIG. 2B is a block diagram illustrating an example embodiment of a functional block diagram of a conventional system 220 functioning within the communications network 125 of FIG. 1. The system 220 illustrates a conventional handoff technique of signal strength-based handoff. The system illustrates handoff of communication with a UE device 226 from a first cell site 222 to a second cell site 224. The first cell site 222 and the second cell site 224 generally include one or more eNodeB devices for radio communication with mobile devices such as the UE device 226. The first cell site 222 and the second cell site 224 further generally operate in conjunction with a core network in a radio access network or mobility network to provide mobility to user devices such as the UE device 226.

In the example of FIG. 2B, the first cell site 222 experiences traffic congestion. Traffic congestion may be manifested as slow response times when a UE device seeks to attach to the cell site, or by degradation of other KPIs. Traffic congestion may be due to approaching or exceeding a threshold number of devices attached to the cell site or handing off from or handing off to the cell site. Traffic congestion may be due to the data throughput at the cell sites approaching or exceeding a threshold, as users activate more data-intensive applications on their mobile devices. Any other suitable standard may be used to conclude that a cell site or eNodeB is experiencing congestion. Separately, second cell site 224 is experiencing normal, non-congested traffic levels.

In a conventional network such as the network 220, handoff is based on signal strength. That is, a UE device such as UE device 226 monitors received signal strength from all base stations in the vicinity of the UE device, including the first cell site 222 and the second cell site 224. In one example, the UE device will measure reference signal received power (RSRP) or reference signal received quality (RSRQ) for the signals from each respective base station. RSRP is a type of received signal strength indicator (RSSI) measurement and represents the received power at the UE device of reference signals broadcast by each base station. RSRQ measures signal quality considering also RSSI and a number of received resource blocks. In one form,

$$RSRQ = \frac{N * RSRP}{RSSI} ,$$

measured over the same bandwidth, where N is the number of received resource blocks. Either an RSRP value or an RSRQ value may be measured when evaluating a handoff. The selected value may be compared with a threshold. As indicated in FIG. 2B, following the determination of RSRP or RSRQ values, or both, and a comparison, the UE device 226 migrates to the cell site having the better RSRP and RSRQ value.

In most cases, if the UE device 226 is closer to the congested site, first cell site 222, the UE device will experience stronger RSRP and RSRQ from that site, the congested first cell site 222. The conventional handover process for the UE device 226 will then select the congested first cell site 222 as the handover destination. However, this is unexpected and may be less than optimal since, due to the congested conditions of the first cell site, the user of the UE device 226 may experience poor QoE when the UE device 226 connects to the congested first cell site 222.

As can be seen, cellular handover in conventional networks, as illustrated in FIG. 2B, is dictated by a static policy. That is, when the signal strength measurements at a UE device meet a predetermined threshold, the UE initiates a handover towards the “best” cell, as determined by measured RSRP and RSRQ. As a result, conventional deployments allow eNodeB devices only a limited opportunity to select the UE devices the eNodeB device wants to serve.

FIG. 2C illustrates a solution which operates to enable an eNodeB device to select the UE devices that the eNodeB wants to serve in order to optimize internal resource utilization. FIG. 2C is a block diagram illustrating an example, non-limiting embodiment of a functional block diagram of a system 230 functioning within the communications network 125 of FIG. 1 in accordance with various aspects described herein. The functional block diagram illustrates operational flow of an improved, QoE-based user handoff operation for a UE device such as UE device 226 operating in conjunction with one or more cell sites or base stations such as first cell site 222 and second cell site 224 illustrated in FIG. 2B.

In accordance with various aspects, a system and method model a network snapshot as a temporal graph, and leverage graph-based machine learning techniques to capture spatial-temporal information and detect abnormal cell sites experiencing a performance issue. For users who will be handed off to impacted cells, the legacy handoff procedure is replaced by a novel QoE-based handoff decision making operation to reject users without high traffic demands, and users with alternative candidate serving cells. Further, a handoff log is maintained for each user to avoid handover loops.

FIG. 2C illustrates a portion of a flow diagram 232 showing an embodiment of a conventional handover procedure for a mobile device in a mobility network. The procedure begins at step 234. At step 236, devices involved in the handover procedure are configured. Configuration may involve the source cell site to which the mobile device is currently attached, one or more neighboring cell sites, including a target cell site to which the mobile device may be handed off, the mobile device itself, and network equipment such as a mobility management entity of a core network which oversees the handover operation.

At step 238, the mobile device measures received signal strengths from base stations at cell sites in the vicinity of the mobile station. Any other suitable measurements may be taken and processed and, further, reported to the source base station and other network locations. Generally, the UE device provides and ordered list of detected base stations of eNodeB devices, along with a detected signal strength. At step 240, in the conventional handover procedure, as illustrated in FIG. 2B, based on signal measurements of step 238, a handoff command may be issued, and the mobile station will hand off to the cell site having better signal strength.

However, as noted, the cell site having better signal strength may be in an abnormal state. In one example, the abnormal state includes traffic congestion or any other condition that may result in a worse quality of experience for the user. Conventionally, the network (such as a mobility management entity) decides when and to what target cell the mobile device should connect to. Conventionally, the network does not take into consideration other factors such as types of applications the mobile device is currently running or what particular latency requirements the mobile device may have. Conventionally, the network assigns the handoff to the cell site with the strongest signal at the top of the list reported by the UE device.

In accordance with embodiments, therefore, the system 230 adds operations to accommodate and prevent the situation of the user being handed over to a worse or abnormal cell. Following the measurement and reporting of step 238, at step 242 it is determined if the cell site selected for a handoff from a source cell will be an abnormal target cell. In various embodiments, an abnormal target cell may be defined in suitable ways. In one example, the target cell is in a condition of relatively high traffic congestion. For example, the test of step 242 may compare a number of mobile devices currently attached to the target cell with a threshold number of cells and, if the number of actual attached cells does not exceed the threshold, the handover is considered normal and control proceeds to step 240 for processing of the handoff command. Any other suitable test for an abnormal cell may be used. In general, an abnormal cell is one that will result in unacceptable quality of experience (QoE) for the user of the mobile device.

If the test of step 242 produces a conclusion that the target cell is an abnormal cell, control proceeds to step 244. In step 244, a QoE-based handoff decision process occurs. The QoE-based handoff decision process of step 244 determines if a hand off should occur and selects a new cell site, base station of eNodeB as the target for the handover. Subsequently, a handover loop check process occurs, step 246. Following the handover loop check process of step 246, the handoff command may be processed at step 240.

The QoE-based handoff decision process of step 244 may use any suitable input information when deciding whether and where a handoff should occur. In the illustrated example, the QoE-based handoff decision process receives information 248 about an inferred application type and information 250 about detected abnormal cells. The information 248 about the inferred application type may serve as an indication that the user of the mobile device is engaged in an interactive application, such as a voice call, video chat, or a gaming application. Interactive applications generally involve a user of the mobile device exchanging conversation or game play or other information with one or more users in real time or near-real time, where the user expects an immediate response from another participant. Such an interactive application would be more susceptible to a reduction in QoE for the user if the call was handed off to an abnormal cell which was heavily congested, disrupting the interactivity between participants. Another example includes an application on a connected car, autonomous vehicle, or other vehicle which relies on a continuous communication connection with a remote source such as a network controller and may have stringent latency requirements. Services such as connected vehicle communications and voice calls have a specified quality of service (QoS) parameter for prioritizing traffic in the network. The QoS value assigned to the service, or the call may be one factor in the determination of step 244. On the other hand, a non-interactive application such as electronic mail or text messaging may not be as disrupted by handover to an abnormal cell. In an embodiment, the QoE-based handoff decision process of step 244 may reject handover requests from less important users with light traffic applications or performance-tolerant applications.

The information 250 about detected abnormal cells may be supplied, for example, by the network which monitors the state of all network elements including the target and source cell sites. The information 250 may be collected and reported in any suitable manner. The information 250 may be used by the QoE-based handoff decision process of step 244 to identify a normal cell with best radio quality. Radio quality may be based on measured RSRP or RSRQ values or other information. If the radio quality is acceptable, the identified normal cell will be set as the handoff target cell.

In another example, the network may receive the request from a UE device to hand off to a particular target cell. However, the network may have information about other activity by other UE devices already attached to the particular target cell or approaching the target cell. The network will decide whether to approve the handover or reject the handover based on all information about the current UE measurements and other traffic and activities in the network.

The handover loop check process of step 246 may include steps to prevent the handover procedure of the system 230 from operating in a continuous loop. Handover targets at cells which have recently been rejected as abnormal cells are excluded from consideration for handover. The handover request from the mobile device may be refused for a period of time to prevent operation from unintended looping. Any suitable period of time, such as one hour or one day, may be chosen. Also, if updated information about a cell site status is received, such as information 250 indicating that the cell site is no longer considered abnormal, then subsequent handover requests to that cell site may be processed.

FIG. 2D is a block diagram illustrating an example, non-limiting embodiment of decision-making logic 260 for a QoE based user handoff system functioning within the communications network 125 of FIG. 1 in accordance with various aspects described herein. The decision-making logic 260 can be implemented in any suitable process, including hardware, software, or a combination of these. Moreover, the decision-making logic 260 can be implemented at any suitable location, or combination of locations, in a network. For example, the decision-making logic 260 may be implemented at a mobility management entity (MME) of a core network of a mobility network, where the MME is in data communication with the eNodeB devices of cell sites of the mobility network. The logic 260 may be initiated by a request to hand off by a UE device which has reported received signal strength information and other network and device status information to a serving base station.

At step 262, the logic 260 determines if the UE device seeks to hand off to an abnormal cell. An abnormal cell may be any type of cell, with any status as described herein, including a cell that is congested with traffic that exceeds a predetermined threshold. The normal handoff would be to a cell site having the strongest received signal strength at the UE device as reported by the UE device. If the UE device does not seek to hand off to an abnormal cell site, control proceeds to step 264 and handoff proceeds normally. For example, the strongest received signal reported by the UE may originate from a cell which has normal levels of traffic, such as traffic levels below a predetermined threshold.

If at step 262 the UE device does seek to hand off to an abnormal cell, at step 266, the logic 260 determines the type of application traffic currently experienced by the UE device. The type of traffic may be categorized in any suitable manner, such as performance-sensitive traffic versus performance-tolerant traffic or heavy traffic versus light traffic. If the user of the UE device is not engaged with an interactive application, such as a voice call, video chat, or game, the logic at step 266 concludes that the UE device traffic is considered to be light traffic or performance tolerant traffic and control proceeds to step 268. At step 268, the decision to hand off is rejected by the logic.

If at step 266 the user of the UE device has an interactive application active on the UE device, a conclusion is drawn that heavy traffic or performance-sensitive traffic is involved at the UE device. Performance-sensitive traffic and performance-tolerant traffic may be defined in any suitable manner. In an example, performance-tolerant traffic may refer to data communicated by an application operating on a network-connected device that is sensitive to one or more network performance metrics, such as a network drop rate or packet loss rate, or a network block rate. In other examples, performance-sensitive traffic may refer to an application sensitive to throughput, latency, or packet loss in the network. For example, some applications are sensitive to latency and packet loss, such as applications for online gaming or applications that control connected cars. In other examples, some applications are sensitive to throughput or bandwidth, such as applications that rely on video streaming and video calls.

Also, some applications are relatively insensitive to any of these metrics. Examples of such applications include web browsing applications, online mapping applications, or applications operating on a device which is currently idle. Such applications may be termed “performance-tolerant” applications. Alternatively, traffic levels exceeding a threshold value for a key performance indicator may be defined to be heavy traffic or performance sensitive traffic and traffic levels not exceeding the threshold value may be defined as light traffic or performance-tolerant traffic. Example, key performance indicators include factors such as data throughput, actual measured latency and requested latency by an application, or a quality of service (QoS) value for the application. In one example, an application requires latency of less than 10 ms. If the latency threshold is 100 ms, the application requiring 10 ms latency would be defined as a performance-sensitive application. An application requesting 500 ms latency would be defined as a performance-tolerant traffic application. In another example, the user may be using the UE device for a voice call or using a gaming application on the UE device that requires back-and-forth interaction by the user and a remote user or device.

Sensitivity for performance-sensitive applications refers to the response of the application if a particular network parameters is not met. Performance-sensitive applications are applications which will provide unsatisfactory performance if a specified network performance metric or key performance indicator is not met. The particular sensitivity may vary from application to application. Unsatisfactory performance may be based on a comparison to a threshold or other value or may be based on a subjective experience of a user of the device. Further, the application may be sensitive to one performance metric, such as throughput, but not be sensitive to another performance metric, such as packet loss rate. Generally, if any application is demanding or sensitive on any key metric that a congested component such as a cell site cannot accommodate, the handoff policy and the communication network should take that into account.

In the case of performance sensitive traffic, at step 270, the logic 260 determines if there are other, alternative cells to which the call could be handed off. If there is at least one other alternative cell to which the interactive call can be handed off, and that has adequate received signal strength as reported by the UE device, at step 272, the logic 260 sets the best alternative cell as the destination cell for the handoff. The best alternative cell may be the cell with the strongest received signal strength. Other factors may be used to identify a best alternative cell.

On the other hand, if there is no suitable alternative cell for a handoff, at step 274, no change is made to the handoff decision which is based on the strongest received signal strength. That is, the conventional decision based on reported measurements from the UE device is only overridden by the logic 260 if a heavy traffic call or application or performance-sensitive application is underway and there are no suitable alternative cells for the handoff. In the example, a heavy traffic call or performance-sensitive application corresponds to a voice call or use of an interactive application or other feature that requires low latency between the UE device and a remote destination.

FIG. 2E is a block diagram illustrating an example, non-limiting embodiment of a functional block diagram of a system 276 and method functioning within the communications network 125 of FIG. 1 in accordance with various aspects described herein. The system 276 may be used to control a handover operation in a mobility network in which a target cell or base station is abnormal in some way, such as being loaded with a relatively high amount of traffic. The handover operation may be in response to a received measurement report from a UE device attached to a cell site, base station or eNodeB. The measurement report includes, for example, a list of detected nearby base stations and received signal strength for each base station. The embodiment of FIG. 2E provides additional exemplary details regarding inference of an application type being used by the UE device, detection of abnormal cells and a handover loop check.

In the embodiment of FIG. 2E, the QoE-based handoff function has two inputs, including information defining detected abnormal cells and information defining an inferred application type being used by the UE device. To determine an application type inference, the system 276 queries near-term historical user data. Such data may be obtained from any suitable source in the network. In the example of FIG. 2E, user traffic logs 277 are retrieved from storage. As the user of the UE device access facilities and services of the mobility network, information about such accesses is stored in a suitable location available over the network. For example, if the user of the UE device uses the device to access the public internet for web surfing and for accessing applications such as a gaming application, this activity may be tracked and recorded in varying levels of detail. Generally, confidentiality and privacy of user information is maintained, for example by avoiding deep packet inspection, so the user traffic log data 277 may be anonymized to a degree.

As noted, for the application type inference process 248, the system 276 queries the near-term historical user data logs 277 to infer an application type of the user of the UE device. By looking at utilization patterns of the network by the user and the UE device, inferences about the user's use of the UE device may be made. In general, each type of application has different, distinct patterns reflected in the data retrieved from the user data logs 277. Such data patterns may indicate, for example, a latency or throughput of the user data. For example, an interactive voice call or video call may have an end-to-end latency expectation of 100 milliseconds, which would mean that the UE device will be communicating to the network or receiving something from the network roughly every 50 milliseconds. Similarly, an interactive application which has a 10-millisecond latency expectation will be sending or receiving something every 10 milliseconds. In an alternative example, a non-interactive application may correspond generally to operation of video systems. In non-interactive video systems such as streaming video, the UE device sends a request for data and then receives a response every five seconds until the system provides 4 minutes' worth of video content.

Based on the data patterns, the system 276 can use this near-term historical data to infer a type of application being used by the user of the UE device. In some examples, the user may be using multiple applications, or have multiple applications active on the UE device. Some applications may operate in the background, with little input from the user. Other applications operate in the foreground with interactive input from the user and receipt of interactive responses from a remote source.

If the application type inference process 248 concludes that the UE device is not engaged in an interactive process, the application type inference process 248 concludes that the UE device is only experiencing light traffic or performance-tolerant traffic. At step 278, the measurement report from the UE device is discarded. Otherwise, a conclusion of heavy traffic or performance-sensitive application is drawn, and, at step 280, an alternative cell search process may occur. The alternative cell search process may use information received about detected abnormal cells in the mobility network.

Once an inference has been made that this user or this UE device needs an interactive application level of QoS, then the eNodeB in some embodiments may use temporal graphs and an associated machine learning algorithm to make a decision on whether or not the mobility network should accept the UE device's handover request. The handover may be completed as requested or the handover may be denied. In that case, the current user and UE device could be served by other eNodeB devices in their area and the current eNodeB could instead wait for another user or UE device who has a more stringent requirement to arrive and serve that user. In that case, local resources at the eNodeB are conserved and an alternative cell is selected.

For the detection of abnormal cells, a set of temporal network graphs 281 are established and maintained for each time step. The temporal network graphs 281 may be constructed at each decision timestamp in the target region. Each temporal graph in an embodiment consists of all active cells as nodes, such as cell 282a and cell 282b in FIG. 2D. Cell-pairs allowing user handoff form edges in the temporal graph, such as edge 283 between cell 282a and cell 282b. For each node, time series data is retrieved from the cell-level KPI logs 284 and the handoff logs 285.

The temporal network graphs 281 may be constructed using any suitable information. In the illustrated example, cell-level key performance indicator (KPI) logs 284 and handoff logs 285 are used to form the temporal network graphs 281 for each time step. In one example, the KPIs of interest relate to collectivity, reliability, retainability and accessibility KPIs. Such KPIs are highly related to whether a particular cell is impacted by nearby outage cell sites Also, or instead, aggregated performance KPIs may be used from the cell-level KPI logs 284. For example, the system 276 monitors factors such as data throughput or packet loss of each user or UE device are served by a site. The performance metrics may be aggregated on the cell site level. The result may be a site level performance metric such as an aggregated throughput value or aggregated packet loss value. The result is a series of temporal network graphs 281 which contains the information of all cell sites and also the handoff information between cell sites. The cell-level KPIs define node features. Handoff user numbers define edge weights.

In an example, a set of eNodeB devices serves a geographic region including a number of cells. Each eNodeB has a current usage pattern which reflects how many users are attached to the eNodeB device. The eNodeB device reports information including the current usage pattern to other components of the network, such as the mobility management entity (MME) located in a core network. Historical patterns may then be used to create a temporal graph to estimate what the usage pattern will look like in the future, such as 10 minutes in the future and 20 minutes in the future. This may be done at a site such as the MME remote from the eNodeB devices.

In the illustrated example, information about the nodes and the edges of the temporal network graphs 281 is provided as an input from this series of network graphs to a machine learning model 286. The input data to the machine learning model 286 may be organized and formatted in any suitable manner. In the example using the temporal network graphs 281, for the input data one dimension is time and a second dimension is location. In the illustrated embodiment, a deep learning graph convolution neural network (GCN), long-term memory network (LSTM) (GCN-LSTM) model is used for the machine learning model 286. Any other suitable model or combination of models may be used. In general, in this example, the input to the machine learning model 286 is spatial-temporal data such as in the temporal network graphs 281. Each node of the graph corresponds to a cell location. The machine learning model 286 operates to classify all cell sites into either abnormal cell sites or normal cell sites. The machine learning model 286 may be trained using any suitable data available, including historical cell-level KPI logs and handoff logs for the mobility network. The output of the machine learning model 286 corresponds to the state of each cell site as abnormal or normal. The output data may be presented as a graph. This may be stored as information 250 about detected abnormal cells. The output data may be considered a snapshot at a particular time of the state of the cell sites and the state may be monitored, over time, at a particular location.

The information 250 about detected abnormal cells is provided as an input to the alternative cell search process of step 280, along with the inferred information about application type 248. The alternative cell search process of step 280 may implement any suitable logic, such as the logic 260 of FIG. 2D, to identify an available alternative cell as a target for handoff from the current source cell.

For performing the handover loop check, the system 276 maintains current handoff logs 287. In an example, the current handoff logs maintain a count of the number of handoff requests which are rejected in a recent time interval, such as five minutes. Any suitable time interval may be used. Any potential target cell which has been a target of a successful handoff in the most recent time interval will be banned as the destination cell of the current handover.

The handover loop check of step 246 relates to a situation where the system 276 of FIG. 2E is implemented at all cell sites in an area and there are UE devices located at boundaries of service areas of each cell site. Such UE devices receive relatively weak signal strength from each cell site. Each eNodeB would reject each of these devices in favor of users located closer to the cell site, with stronger received signal. Such stronger-signal devices could be served better by the cell site because they have better signal strength. In an example, a UE device receiving relatively strong signal strength from a cell site or eNodeB and involved in an interactive function such as a voice call, would use, for example, 10 physical resource blocks for the interactive application. A physical resource block is a time and frequency resource that occupies a predetermined bandwidth and time duration. On the other hand, for the UE device located at the edge of a cell site coverage area, delivering the same content may require 30 to 40 physical resource blocks. This is a function of several factors, including the latency requirement of the interactive application. As a result, the eNodeB servicing the UE device at the cell site edge spends extra resource blocks to deliver application packets to the UE device, relative to the UE device located closer to the center of the service area and receiving a stronger signal. For the sake of system efficiency, the eNodeB attempts to optimize for the least possible physical resource blocks used to meet the user's QoS requirements. If each eNodeB operates accordingly, the UE device at the cell boundary will never be given a handoff because the system 269 seeks to conserve eNodeB resources during a handoff.

The handover loop check of step 246 operates to prevent this occurrence. Once a UE device has been rejected for a handover a predetermined number of times, the device will not be further rejected and will be assigned a handover. Any suitable number, such as 4 or 8 may be selected as the loop check value. Each time a UE device requests a handover and is rejected, a counter of the handover loop check of step 246 is incremented. If the counter value exceeds a threshold, such as 4 or 8, the rejection of the handover is overruled, and the handover is allowed to proceed.

Handover loop examples follow. In general, the network (through an eNodeB) will request the UE device to measure what cells it can attach to. In response, the device will provide a list of cells it detects, along with received signal strength information for example. The network will then decide which of the cell sites the device should attach to. In some cases, the network triggers the handoff on behalf of the UE device.

In the following handover loop examples, a UE device detects multiple eNodeB devices, designated eNB A, eNB B and eNB C. Based on received signal strength, the UE device prefers eNB A over eNB B and prefers eNB B over eNB C (that is, A>B>C), and is currently attached to eNB C. In a first loop type, a UE device is trying multiple eNodeB devices during handoff. In a second loop type, the eNodeB device continues to request handoff to the same eNodeB device.

In a first example, according to protocol, the UE device should be handed off to eNB A, as the cell site with the strongest received signal. However, in the example, eNB A rejects the handoff request. For example, eNB A may be in a state where it should not accept a handoff. Instead, the UE device and the network try to hand off to eNB B and, in the example, eNB B accepts the request. The UE device therefore attaches to eNB B. To prevent further handoff attempts and increased unnecessary network traffic, eNB B adds the rejecting eNodeB device, eNB A, to a temporary access control list. The access control list includes other eNodeB devices to which handoff of the UE device should not be attempted. Periodically, eNB B will ask the UE device to measure received signal strength and determine which eNB can serve the UE device best. In the example, the UE device again returns the list A>B>C. According to network protocol, the UE should be handed off to eNB A. However, it's already known that eNB A is not accepting handoffs including the UE device.

Accordingly, the eNodeB may maintain a loop counter for each UE device attached to the eNodeB. The counter may be incremented for each failed attempt, or each rejected attempt, at handover to the designated eNodeB, or eNB A in this example. All further requests for handoff to eNB A by devices with similar RSRP/RSRQ will be disabled for a time duration time by a timer. The timer may be frequently cleared, such as every 5 minutes, to permit re-attempts at handover to eNB A. In embodiments, this applies to both inter-eNodeB handoff attempts and intra-eNodeB handoff attempts, where the UE device is handed off from one frequency or sector of an eNodeB to another on the same eNodeB.

In the example, if the loop counter for a designated UE device indicates that a an eNodeB, such as eNB A in this example, has rejected a requested handover a predetermined number of times, or within a predetermined time duration, the eNodeB will be discarded or disregarded as a handover candidate by eNB B. The predetermined number of times many any suitable value, including 1 time, and the predetermined time duration may be any suitable value, such as 5 minutes. Thus, in this example, eNB B will discard cells such as eNB A which have been rejected in the past 5 minutes. The device eNB B will not try to send UE devices to eNB B for a fixed amount of time, such as 5 minutes. The time duration may be tracked by a timer. After a time, or periodically, the timer value may be cleared and eNB B will again try to handover the UE device or another UE device to eNB A.

In another example, the UE device again returns the list A>B>C and the UE device is currently attached to eNB C. In the example, the network seeks to hand off the UE device to eNB A which rejects it, then the network seeks to hand off the UE device to eNB B which also rejects it. The UE device remains camped on eNB C. However, the UE device is mobile and can move to some degree, and in the example, as the UE device moves, the coverage of signal strength received at the UE device from eNB C may degrade. In that case, either eNB A or eNB B must accept the handoff from eNB C. The UE device cannot be kept in an infinite loop, unable to handover out of its poor coverage area. In that case, an administrative override is introduced. In that case, eNB B retains a record of which handoff requests it has rejected, including the one from the UE device now experiencing service degradation. Under the override condition, if the same UE device sends another handoff request within a predetermined time, such as 10 minutes, the eNB B must accept the handoff request. This prevents the UE device experiencing poor coverage or in need of a handover to switch to an eNodeB with adequate coverage. In accordance with this embodiment, then each eNodeB device maintains a list of UE devices which the eNodeB device has rejected as a handoff target. From time to time, the list is cleared.

At step 288, if appropriate, the destination cell for the handover request by the UE device is updated according to the results of the alternative cell search process of step 280 and the handover loop check of step 246. Identifying information for the selected destination cell is forwarded to the handoff request step 240 and the handoff logs 287 are updated with the information about the selected destination cell.

Thus, the system 276 provides an improved method for handling a handover request from a UE device in a mobility network. The system 276 provides initially for modelling a network snapshot as temporal graphs. The system 276 further leverages graph-based machine learning techniques to capture spatial-temporal information and detect abnormal cells having a performance issue. For users and UE devices who will be handed off to normal cells, a conventional handoff procedure is replaced by a novel QoE-based handoff decision procedure. The QoE procedure operates to reject users without high traffic demands and users with alternative candidate serving cells. Further, a handoff log is maintained for each user to avoid handover loops.

Initially, one or more temporal graphs are constructed at each decision timestamp in a target region. The temporal graph consists of all active cells as nodes in the graph and cell-pairs which allow user handoff as edges in the graph. Cell-level KPIs are set as node features and handoff user numbers are set as edge weights. The series of temporal graphs serve as the input to a machine learning model to perform node classification to detect cells with performance issues.

When a handover request is received, the request includes a list of cell sites detected by the UE device and received signal strengths from each cell site. For users or UE devices who request to be handed off to abnormal cells, the application type currently accessed by the user is determined based on near-term historical data. If the user is idle or using light-traffic applications or performance-tolerant applications, the handoff request is rejected.

The radio quality or signal strength of all cells reported by the UE device, including the current serving cell, is determined from the measurement report which triggers the handoff request. A normal cell having the best radio quality or signal strength is identified and compared with the radio quality of the original destination cell of the handover request. If the difference is less than a threshold, the normal cell is selected as the new destination cell. Any suitable threshold may be selected. A variable threshold that responds to current network conditions may be selected as well.

The techniques disclosed herein provide many unique advantages. For example, during busy hour or outage conditions, when network traffic is relatively heavy and congestion may occur, the eNodeB devices may select the UE devices they wish to serve. That is, the eNodeB may elect to serve an eNodeB located to receive a strong received signal and therefore requiring fewer physical resource blocks for providing a service. A more remotely located UE device, near a cell edge, for example, may require more resource blocks for the same communication and therefore reduce overall system efficiency. Further, the techniques herein allow eNodeB devices to construct graphs showing which eNodeB devices in the area are impacted by an outage or other abnormal condition or are likely to be impacted in the future. Similarly, an eNodeB can share with adjacent cells impacted or future impacts due to congestion and other causes, informing the adjacent cells of current and future status. This awareness improves network operation and efficiency.

While for purposes of simplicity of explanation, the respective processes are shown and described as a series of blocks in FIG. 2C and FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

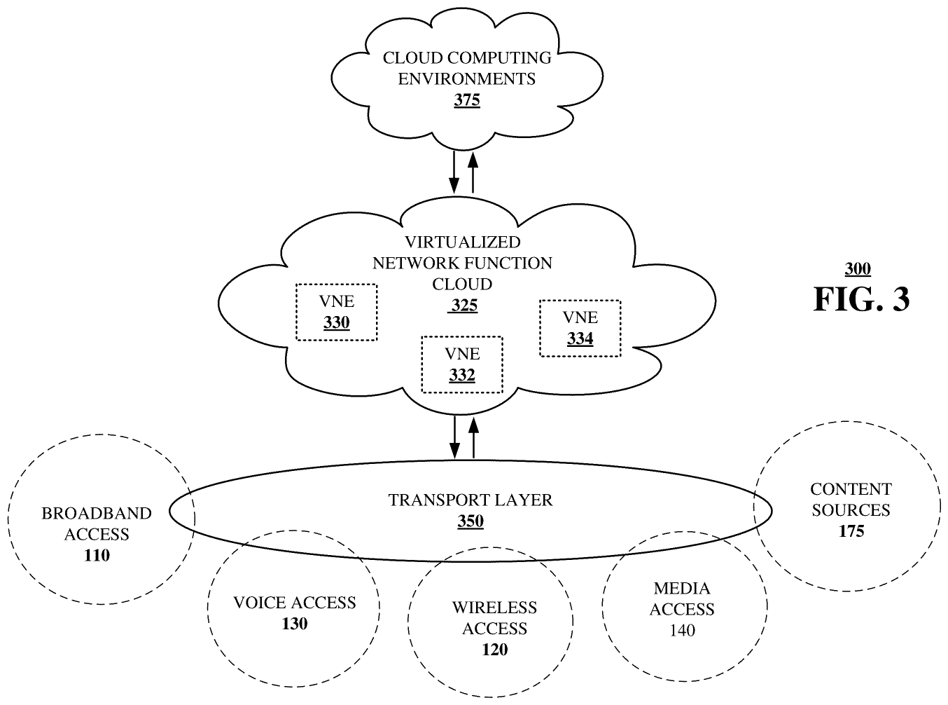

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, and method 230 presented in FIG. 1, FIG. 2A, FIG. 2B, FIG. 2C, FIG. 2D, FIGS. 2E, and 3. For example, virtualized communication network 300 can facilitate in whole or in part receiving a handover request from a user equipment (UE) device in a mobility network, determining if a target cell for the handoff is in an abnormal state, such as a cell outage or congestion due to traffic, inferring a type of traffic present in the UE device and selecting an alternative handover target for the handover request.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

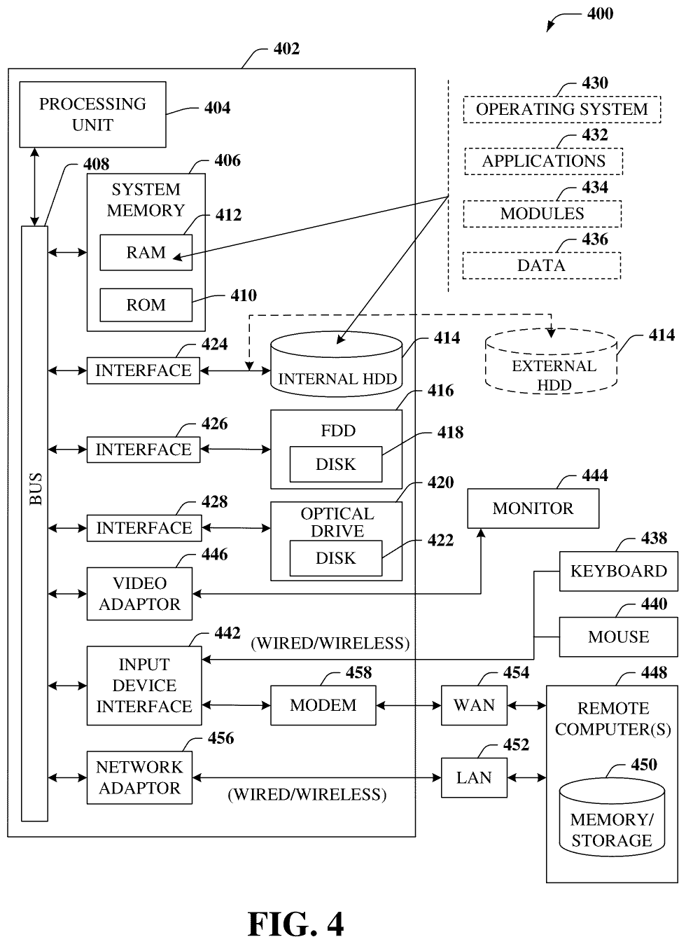

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving a handover request from a user equipment (UE) device in a mobility network, determining if a target cell for the handoff is in an abnormal state, such as a cell outage or congestion due to traffic, inferring a type of traffic present in the UE device and selecting an alternative handover target for the handover request.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

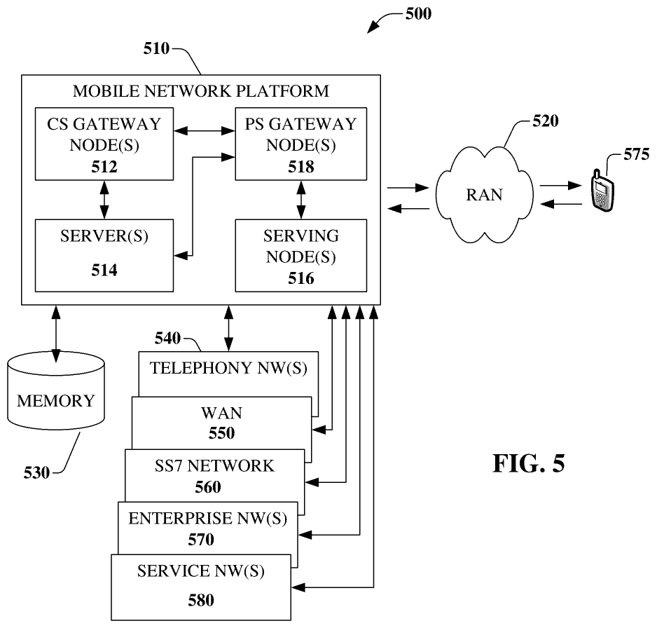

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving a handover request from a user equipment (UE) device in a mobility network, determining if a target cell for the handoff is in an abnormal state, such as a cell outage or congestion due to traffic, inferring a type of traffic present in the UE device and selecting an alternative handover target for the handover request. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

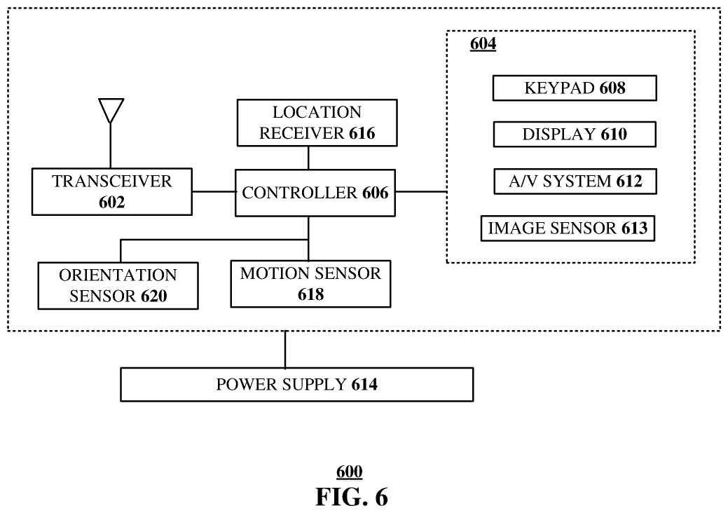

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving a handover request from a user equipment (UE) device in a mobility network, determining if a target cell for the handoff is in an abnormal state, such as a cell outage or congestion due to traffic, inferring a type of traffic present in the UE device and selecting an alternative handover target for the handover request.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stories executable instructions that, when executed by the processing system, facilitate performance of operations, the operations comprising:
receiving a handover request from a user equipment (UE) device in a mobility network;
identifying a target cell for handing over radio communication with the UE device from a source cell, wherein the identifying is based on the handover request;
determining a usage level of the UE device, wherein the usage level comprises one of performance-sensitive traffic and performance-tolerant traffic;
selecting an alternative target cell for the handover request, wherein the selecting is responsive to determining a performance-sensitive traffic usage level of the UE device; and
initiating a handover operation between the source cell and the alternative target cell.

2. The device of claim 1, wherein the determining the usage level of the UE device comprises:
receiving user traffic log information for the UE device; and
inferring the usage level of the UE device based on the user traffic log information.

3. The device of claim 2, wherein the operations further comprise:
identifying one or more applications currently active on the UE device; and
inferring the usage level of the UE device based on information about the one or more applications.

4. The device of claim 3, wherein the operations further comprise:
identifying an interactive application currently active on the UE device among the one or more applications; and
inferring the performance-sensitive traffic usage level of the UE device based on the identifying the interactive application.

5. The device of claim 1, wherein the selecting the alternative target cell comprises:
receiving from the UE device a list of adjacent cells detected by the UE device;
identifying one or more handover candidate cells among the list of adjacent cells; and
selecting the alternative target cell as a handover candidate cell having satisfactory radio quality.

6. The device of claim 1, wherein the operations further comprise:
identifying abnormal cells having an abnormal operating state and normal cells having a normal operating state; and
identifying one or more normal handover candidate cells among the normal cells having a normal operating state.

7. The device of claim 6, wherein the operations further comprise:
determining the target cell is an abnormal cell;
inferring the performance-sensitive traffic usage level of the UE device based on the identifying an interactive application active on the UE device; and
selecting a normal handover candidate cell as the alternative target cell, wherein the selecting is based on a comparison of received radio quality from the normal handover candidate cell at the UE device and received radio quality from the target cell at the UE device.

8. The device of claim 7, wherein the operations further comprise:
forming temporal network graphs for the mobility network, the temporal network graphs including active cells of the mobility network as nodes of the temporal network graphs and cell pairs allowing user handoffs as edges between the nodes of the temporal network graphs;
providing information of the temporal network graphs to a machine learning model; and
receiving, from the machine learning model, information identifying one of a normal state or an abnormal state for each cell of the active cells of the mobility network.

9. The device of claim 1, wherein the operations further comprise:
receiving an indication that the alternative target cell has rejected a handover request for the UE device;
adding identification information for the alternative target cell to a temporary access control list; and
disabling handover attempts to cells, including the alternative target cell, on the temporary access control list for a predetermined time.

10. The device of claim 9, wherein the operations further comprise:
timing the predetermined time on a local timer; and
resetting the local timer after a predetermined duration.

11. A non-transitory machine-readable medium, comprising executable instructions that, when executed by a processing system including a processor, facilitate performance of operations, the operations comprising:
receiving, at a cell site of a mobility network, a handover request from a user equipment (UE) device in the mobility network, the UE device attached to the cell site, the handover request including a list of adjacent cell sites detected by the UE device and respective received signal strength information for each adjacent cell site on the list of adjacent cell sites;
identifying a target cell for handoff of the UE device based on the list of adjacent cell sites;
determining the target cell for handoff is an abnormal cell having an abnormal operating state;
determining a current traffic level type of the UE device;
rejecting a handover for the UE device in response to the current traffic level type of the UE device corresponding to a performance-tolerant traffic value;
selecting an alternative target cell for the handover for the UE device in response to the current traffic level type of the UE device corresponding to a performance-sensitive traffic value; and
initiating a handover operation for communication between the UE device and the alternative target cell.

12. The non-transitory machine-readable medium of claim 11, wherein the determining the current traffic level type of the UE device comprises:
inferring the current traffic level type of the UE device based on information about utilization pattern of the UE device and the mobility network.

13. The non-transitory machine-readable medium of claim 12, wherein the determining the current traffic level type of the UE device comprises:
receiving user traffic log information for the UE device; and
based on the user traffic log information, identifying a type of application in use at the UE device.

14. The non-transitory machine-readable medium of claim 13, wherein the identifying the type of application in use at the UE device comprises:
inferring an application type, wherein the inferring the application type comprises inferring the application is one of an interactive application in use by a user of the UE device and a non-interactive application; and
determining the current traffic level type of the UE device based on the inferring the application type.

15. The non-transitory machine-readable medium of claim 11, wherein the operations further comprise:
forming temporal network graphs for the mobility network, the temporal network graphs including active cells of the mobility network as nodes of the temporal network graphs and cell pairs allowing user handoffs as edges between the nodes of the temporal network graphs;
providing information of the temporal network graphs to a machine learning model;
receiving, from the machine learning model, information identifying one of a normal state or an abnormal state for each cell of the active cells of the mobility network; and
selecting a normal cell having a normal state as the alternative target cell.

16. The non-transitory machine-readable medium of claim 11, wherein the operations further comprise:
identifying an abnormal state for a selected cell of the mobility network based on a communication traffic congestion level of the selected cell exceeding a congestion threshold.

17. A method, comprising:
receiving, by a processing system including a processor of an eNodeB device, a handover request from a user equipment (UE) device in a mobility network;
identifying, by the processing system, a target cell for handoff of the UE device, wherein the target cell is based on information of the handover request;
receiving, by the processing system, cell state information for cells of the mobility network, including receiving abnormal cell identification information identifying abnormal cells of the mobility network having an abnormal operating state and receiving normal cell identification information identifying normal cells of the mobility network having a normal operating state;
identifying, by the processing system, the target cell as an abnormal cell;
inferring, by the processing system, a traffic usage level of the UE device, wherein the traffic usage level is one of performance-sensitive traffic at the UE device and performance-tolerant traffic at the UE device;
selecting, by the processing system, an alternative target cell for the handover request, wherein the selecting is responsive to determining a performance-sensitive traffic usage level of the UE device; and
initiating, by the processing system, a handover operation between the eNodeB and the alternative target cell.

18. The method of claim 17, wherein the receiving cell state information for the cells of the mobility network comprises:
receiving, by the processing system, output information from a machine learning model, the output information identifying the abnormal cells and the normal cells of the mobility network, the output information based on a conclusion by the machine learning model for a state of the cells of the mobility network based on spatial data and temporal data of key performance indicators for the cells of the mobility network.

19. The method of claim 18, comprising:
forming, by the processing system, a temporal network graph for a portion of the mobility network, the temporal network graph including active cells of the mobility network as nodes of the temporal network graphs and cell pairs allowing user handoffs as edges between the nodes of the temporal network graphs; and
providing, by the processing system, information of the temporal network graphs to the machine learning model.

20. The method of claim 17, wherein the inferring the traffic usage level of the UE device comprises:
receiving, by the processing system, user traffic logs for the UE device; and
identifying, by the processing system, one of an interactive application and a non-interactive application operating on the UE device, wherein the identifying is based on the user traffic logs.
